(19) United States
(12) Patent Application Publication
(10) Pub. No.: US 2019/0113114 A1
(43) Pub. Date: Apr. 18, 2019

(54) HYDRAULIC TENSIONER WITH INTEGRATED PRESSURE RELIEF VALVES

(71) Applicant: BorgWarner Inc., Auburn Hills, MI (US)

(72) Inventor: Jeremy BENN, Auburn, NY (US)

(21) Appl. No.: 16/158,367

(22) Filed: Oct. 12, 2018

Related U.S. Application Data
(60) Provisional application No. 62/571,509, filed on Oct. 12, 2017.

(51) Int. Cl. F16H 7/08; F16K 27/02; F16K 15/02; F16H 7/06

(52) U.S. Cl. CPC F16H 7/08; F16K 27/0209; F16K 15/025; F16H 7/06; F16H 2007/0853; F16H 2007/0814; F16H 2007/0893; F16H 2007/0872; F16H 2007/0806

(57) ABSTRACT

A hydraulic tensioner includes a valve seat, first valve member, retainer, and second valve member. The seat includes a first aperture disposed about an axis and a second aperture radially outward thereof. The first member includes a first plate having a third aperture aligned with the first aperture. The first plate extends radially outward of the second aperture. The first plate is axially movable between a closed position wherein it inhibits flow through the second aperture, and an open position wherein it permits flow through the second aperture. The retainer includes a second plate fixed relative to the seat. The second member includes a third plate between the second plate and valve seat. The third plate is axially movable between a closed position wherein it inhibits flow through the first aperture while permitting flow through the second aperture, and an open position wherein it permits flow through the first aperture.

### CROSS-REFERENCE TO RELATED APPLICATIONS

This application claims the benefit of U.S. Patent Application No. 62/571,509 filed on Oct. 12, 2017, the disclosure of which is herein incorporated by reference in its entirety.

### FIELD

The present disclosure relates to hydraulic tensioners that have integrated pressure relief valves.

### BACKGROUND

This section provides background information related to the present disclosure which is not necessarily prior art.

Chain drive systems include a drive sprocket and at least one driven sprocket, that receives rotary power from the drive sprocket via a flexible, endless chain. One such example of a chain drive system is a chain driven camshaft of an internal combustion engine. Generally, it is important to impart and maintain a certain degree of tension in the chain to prevent noise, slippage, or the unmeshing of teeth in the case of a toothed chain.

Hydraulic tensioners are one type of device typically used to maintain proper chain tension. In general, these mechanisms employ a lever arm that pushes against the chain on the slack side of the power transmission system. This lever arm pushes toward the chain, tightening the chain, when the chain is slack, and retracts away from the chain when the chain tightens. While current hydraulic tensioners are generally suitable for certain applications, there exists a need for improved hydraulic tensioners.

### SUMMARY

This section provides a general summary of the disclosure, and is not a comprehensive disclosure of its full scope or all of its features.

In one form, the present disclosure provides for a hydraulic tensioner for a wrapped power transmission device between two rotating members. The hydraulic tensioner can include a housing, a piston, a piston spring, a valve seat, a first valve member, a first valve spring, a valve retainer, a second valve member, and a second valve spring. The housing can include a first cavity and a passageway. The passageway can be open into an inward end of the first cavity. The piston can be disposed about the axis. An inward end of the piston can be disposed within the first cavity. An outward end of the piston can be external of the housing. The piston can be configured to slide axially relative to the housing. The piston spring can be disposed within the first cavity and can bias the piston in an outward direction toward the power transmission device. The valve seat can include a first aperture and a second aperture that extend axially through the valve seat. The first aperture can be aligned with the first aperture. The second aperture can be radially outward of the first aperture. The first valve member can include a first plate that can include a third aperture. The third aperture can be disposed about the axis. The first plate can extend radially outward of the second aperture. The first plate can be axially movable between a closed position wherein the first plate seals with an inward side of the valve seat to inhibit fluid flow through the second aperture, and an open position wherein the first plate is axially spaced apart from the valve seat to permit fluid communication through the second aperture. The first valve spring can bias the first plate toward the closed position of the first plate. The valve retainer can include a second plate that can be fixedly coupled to the valve seat. The second valve member can include a third plate disposed axially between the second plate and the valve seat. The third plate can extend radially outward of the first aperture. The second aperture can be radially outward of the third plate. The third plate can be axially movable between a closed position wherein the third plate seals with an outward side of the valve seat to inhibit fluid communication through the first aperture while permitting fluid communication through the second aperture, and an open position wherein the third plate is axially spaced apart from the valve seat to permit fluid communication through the first aperture. The second valve spring can bias the third plate toward the closed position of the third plate.

According to a further embodiment, the valve retainer can include a sidewall disposed about the axis. The sidewall of the valve retainer can extend axially from the second plate in an inward direction toward the valve seat and can fixedly couple the second plate to the valve seat.

According to a further embodiment, the first cavity can include a first cylindrical portion and a shoulder. The piston can be disposed in the first cylindrical portion. The shoulder can extend radially inward of the first cylindrical portion and can abut an inward side of the valve seat to inhibit inward axial movement of the valve seat.

According to a further embodiment, the piston spring can contact an outward side of the second plate.

According to a further embodiment, the valve seat can include a recess. A distal end of the sidewall of the retainer can be disposed in the recess of the valve seat.

According to a further embodiment, the second valve member can include a sidewall. The sidewall of the second valve member can extend axially from the third plate in an outward direction toward the second plate.

According to a further embodiment, the second valve spring can contact an inward side of the second plate and an outward side of the third plate.

According to a further embodiment, the sidewall of the valve retainer can include a plurality of apertures extending radially through the sidewall of the valve retainer.

According to a further embodiment, the valve seat can include a plurality of the second apertures.

According to a further embodiment, the first valve member can include a sidewall. The sidewall of the first valve member can extend axially from the first plate in an inward direction away from the valve seat.

According to a further embodiment, the third plate can include a metering aperture aligned with the first aperture.

According to a further embodiment, the second plate can include an aperture that is coaxial with the axis.

In another form, the present disclosure provides for a hydraulic tensioner for a wrapped power transmission device between two rotating members. The hydraulic tensioner can include a housing, a piston, a piston spring, a valve seat, a first valve member, a first valve spring, a valve retainer, a second valve member, and a second valve spring. The housing can include a first cavity and a passageway. The passageway can be open into an inward end of the first cavity. The piston can be disposed about the axis. An inward end of the piston can be disposed within the first cavity. An outward end of the piston can be external of the housing. The piston can be configured to slide axially relative to the housing. The piston spring can be disposed within the first cavity and can bias the piston in an outward direction toward the power transmission device. The valve seat can include a first aperture and a second aperture. The first and second apertures can extend axially through the valve seat. The first aperture can be disposed about the axis. The second aperture can be radially outward of the first aperture. The first valve member can include a first plate. The first plate can include a third aperture. The third aperture can be disposed about the axis and can be aligned with the first aperture. The first plate can extend radially outward of the second aperture. The first plate can be axially movable between a closed position wherein the first plate contacts an inward side of the valve seat to inhibit fluid flow through the second aperture, and an open position wherein the first plate is axially spaced apart from the valve seat to permit fluid communication through the second aperture. The first valve spring can bias the first plate toward the closed position of the first plate. The valve retainer can include a second plate, a sidewall, and at least one aperture. The second plate can be axially spaced apart from the valve seat. The sidewall of the valve retainer can extend axially inward from the second plate toward the valve seat. A distal end of the sidewall of the valve retainer can be fixedly coupled to the valve seat. The at least one aperture of the valve retainer can extend through the second plate or the sidewall of the valve retainer. The second valve member can include a third plate disposed axially between the second plate and the valve seat. The third plate can extend radially outward of the first aperture. The second aperture can be radially outward of the third plate. The third plate can be axially movable between a closed position wherein the third plate contacts an outward side of the valve seat to inhibit fluid communication through the first aperture while permitting fluid communication through the second aperture, and an open position wherein the third plate is axially spaced apart from the valve seat to permit fluid communication through the first aperture. The second valve spring can be disposed between the second and third plates and can bias the third plate toward the closed position of the third plate.

According to a further embodiment, the second valve member can include a sidewall that can be disposed about the axis and extend axially from the third plate toward the second plate.

According to a further embodiment, the third plate can include a metering aperture aligned with the first aperture.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a sectional view of a power transmission device including a tensioner in accordance with the present teachings;

FIG. 2 is a sectional view of a portion of the tensioner of FIG. 1, illustrating a valve of the tensioner in a first condition;

FIG. 3 is a sectional view similar to FIG. 2, illustrating the valve in a second condition; and

FIG. 4 is a sectional view similar to FIG. 2, illustrating the valve in a third condition.

Corresponding reference numerals indicate corresponding parts throughout the several views of the drawings.

### DETAILED DESCRIPTION

Example embodiments will now be described more fully with reference to the accompanying drawings.

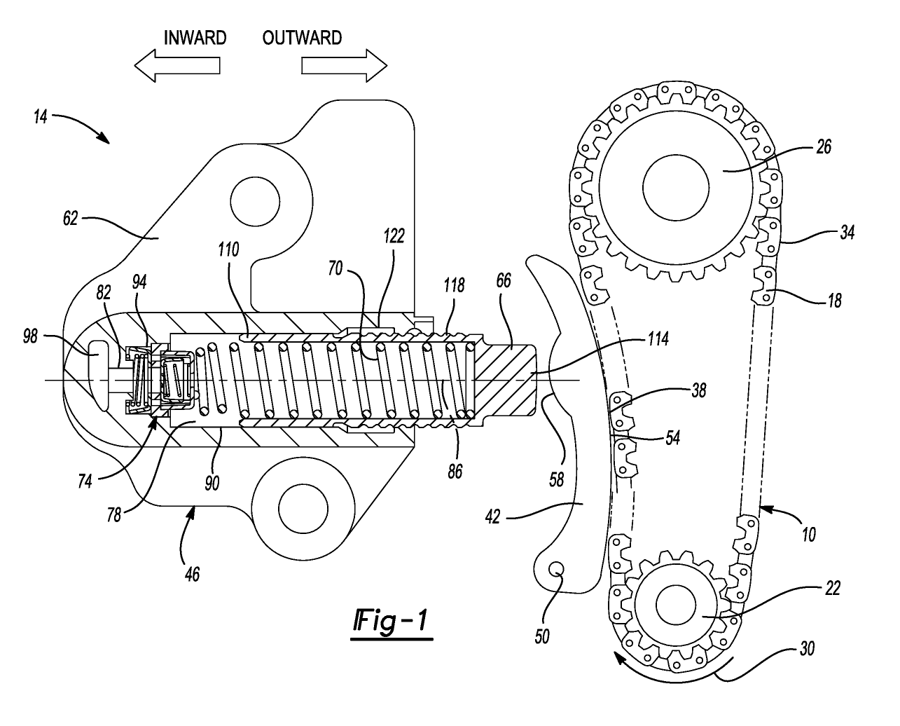

With reference to FIG. 1, a power transmission device 10 and a tensioner device 14 are illustrated. The power transmission device 10 can include a chain 18, commonly referred to as an endless chain, a drive sprocket 22, and at least one driven sprocket 26. While the example illustrated only shows one driven sprocket 26, additional sprockets (e.g., two or more) can be driven by the chain 18. In the example provided, the drive sprocket 22 is coupled to a crankshaft (not shown) of an internal combustion engine (not shown) for common rotation, and the driven sprocket 26 is coupled to a camshaft (not shown) of the engine's valve train (not shown), though other configurations can be used. In the example provided, the drive sprocket 22 rotates in the clockwise direction as illustrated by arrow 30, such that the chain has a tension side 34 and a slack side 38 relative to the drive and driven sprockets 22, 26. The chain 18 and sprockets 22, 26 can be configured in any suitable compatible manner known in the art, such as roller chains and sprockets having corresponding teeth that extend radially outward for example. While only a few of the teeth are illustrated in FIG. 1 for simplicity purposes, it is understood that the teeth of the sprockets 22, 26 extend about the entire circumference of the respective sprockets 22, 26.

The tensioner device 14 can include a lever arm 42 and a tensioner 46. Those of skill in the art will appreciate that the tensioner device 14 and lever arm 42 of FIG. 1 are not necessarily drawn to scale with relation to the power transmission device 10 and the power transmission device 10 may be different in size relative to the tensioner device 14 and lever arm 42. The lever arm 42 can be mounted on a pivot 50. The pivot 50 can be fixed relative to the engine (not shown) such that its position can be fixed relative to the power transmission device 10. For example, the pivot 50 can be fixed to the engine block (not specifically shown). The lever arm 42 can be pivotably coupled to the pivot 50 such that the lever arm 42 can rotate or pivot about the pivot 50. The lever arm 42 can have a first side 54 that can engage an outer portion of the slack side 38 of the chain 18, e.g., between the sprockets 22, 26. The lever arm 42 can have a second side 58 that is opposite the first side 54.

The tensioner 46 can include a housing 62, a plunger 66, a plunger spring 70, and a valve assembly 74. The housing 62 can be fixedly coupled to the engine (not shown) or another structure (not shown) having a position fixed relative to the power transmission device 10 and the pivot 50. The housing 62 can define a first cavity 78 and a fluid passageway 82. The first cavity 78 can be generally cylindrical in shape, disposed about a central axis 86, and can have a first cylindrical portion 90 and a valve recess 94. The first cylindrical portion 90 can have one end open through a side of the housing 62 that faces toward the power transmitting device 10. The opposite end of the first cylindrical portion 90 can be open to the valve recess 94. The fluid passageway 82 can couple the valve recess 94 with a reservoir 98 for fluid communication therebetween.

The reservoir 98 can be configured to hold a volume of fluid at an elevated pressure. The reservoir 98 can be separate from the housing 62 and coupled to the fluid passageway 82 for fluid communication therewith, or can be integrally formed in the housing 62. The reservoir 98 can receive pressurized fluid from a pressure source, such as a pump (not specifically shown) so that the fluid in the reservoir 98 can be maintained at a predetermined pressure. In the example provided, the pump (not shown) can be driven directly or indirectly by the crankshaft (not specifically shown), though other configurations can be used (e.g., an electric pump).

The plunger 66 can be a generally hollow cylindrical body that can have an open end 110 and a closed end 114. The plunger can be coaxial with the central axis 86 and disposed partially within the first cylindrical portion 90 such that the open end 110 is within the first cavity 78 and open into the first cavity 78 for fluid communication therewith. The plunger 66 can extend through the open end of the first cylindrical portion 90 such that the closed end 114 of the plunger 66 can be disposed external of the housing 62. The closed end 114 of the plunger 66 can engage the second side 58 of the lever arm 42. The plunger 66 can be axially slidable within the first cylindrical portion 90 and can be in sealing relation with the housing 62 such that the plunger 66 closes the open end of the first cylindrical portion 90. In the example provided, an outer cylindrical surface of the plunger 66 is in sealing engagement with an inner surface of the first cylindrical portion 90, though other configurations can be used, such as o-rings or other seals (not specifically shown) for example.

An outer surface of the plunger proximate to the closed end 114 can include a plurality of ratchet teeth 118 that can engage a ratchet retaining member (not specifically shown), such as a spring c-clip disposed in a recess 122 in the housing 62 proximate to the open end of the first cylindrical portion 90. The ratchet retaining member (not shown) can engage the ratchet teeth 118 in a ratcheting manner, such that the plunger 66 can move in the outward direction from the first cavity 78, while inhibiting the plunger 66 from moving in the opposite, inward direction. The teeth 118 and retaining member (not shown) can be configured such that a small amount of movement (e.g., approximately 0-4 mm) in the inward direction may be possible before the teeth 118 and retaining member (not shown) engage to inhibit further inward movement. This small amount of movement in the inward direction before the teeth 118 engage the retaining member (not shown) can be referred to as “bang-lash”.

The plunger spring 70 can be disposed within the first cavity 78 and configured to bias the plunger 66 axially in the outward direction (e.g., into contact with the lever arm 42). In the example provided, the plunger spring 70 is a coiled compression spring disposed coaxially about the central axis 86. The plunger spring 70 can extend through the open end 110 of the plunger 66 such that one end of the plunger spring 70 is disposed within the plunger 66 and the other end of the plunger spring 70 is disposed outside the plunger 66 within the first cavity 78.

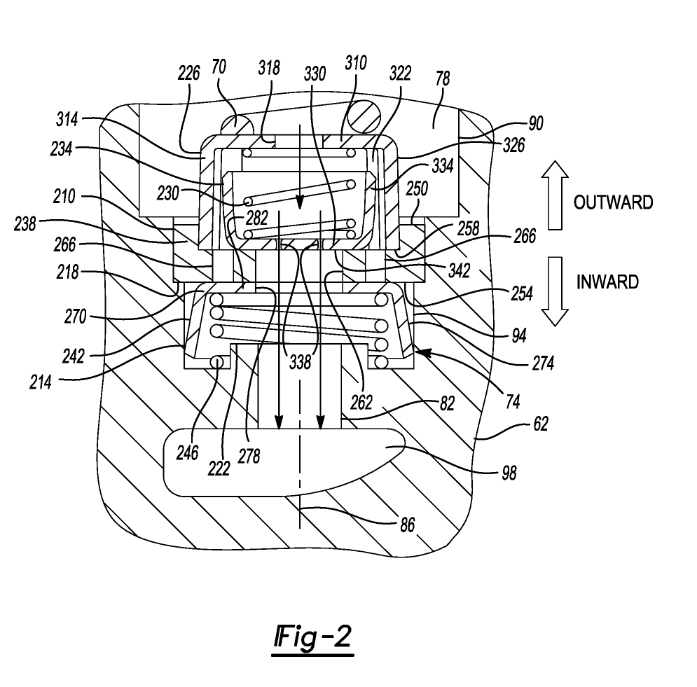

With additional reference to FIG. 2, the valve recess 94 can be coaxial with the central axis 86. In the example provided the valve recess 94 can include a second cylindrical portion 210 and a third cylindrical portion 214. The second cylindrical portion 210 can be open toward the first cylindrical portion 90 of the first cavity 78. In the example provided, the second cylindrical portion 210 can have a diameter that is less than a diameter of the first cylindrical portion 90. In other words, in the example provided, the first cavity 78 steps down in diameter from the first cylindrical portion 90 to the second cylindrical portion 210. In an alternative configuration, not specifically shown, the first cylindrical portion 90 can be the same diameter as the second cylindrical portion 210.

The third cylindrical portion 214 can be open to the second cylindrical portion 210 and the fluid passageway 82, such that the third cylindrical portion 214 is axially between the second cylindrical portion 210 and the fluid passageway 82. In the example provided, the third cylindrical portion 214 can have a diameter that is less than the diameter of the second cylindrical portion 210. In other words, in the example provided, the first cavity 78 steps down in diameter from the second cylindrical portion 210 to the third cylindrical portion 214, such that the step down in diameter therebetween can define a shoulder 218.

In the example provided, the fluid passageway 82 can be coaxial with the central axis 86. In the example provided, the fluid passageway 82 defines a boss 222 that can extend axially into the third cylindrical portion 214 of the first cavity 78.

The valve assembly 74 can include a check valve retainer 226, a check valve spring 230, a check valve cup member 234, a valve seat 238, a pressure relief valve member 242, and a pressure relief valve spring 246.

The valve seat 238 can be disposed within and form a seal with the second cylindrical portion 210. In the example provided, the valve seat 238 can be generally annular in shape and can have an outer cylindrical surface that can have a diameter equal to or slightly larger than the diameter of the second cylindrical portion 210, such that the valve seat 238 can be press-fit into the second cylindrical portion 210. The valve seat 238 can abut against and can seal with the shoulder 218 to inhibit axial movement of the valve seat 238 in the inward direction. The valve seat 238 can divide the first cavity 78 into an inner portion of the first cavity 78 and an outer portion of the first cavity 78.

The valve seat 238 can include an outward side 250, an inward side 254, a recess 258, a first aperture 262, and at least one second aperture 266. The outward side 250 can face axially in the outward direction. The inward side 254 can be opposite from the outward side 250 and can face in the inward direction. In the example provided, recess 258 can be recessed inward from the outward side 250 and can have a generally cylindrical shape coaxial with the central axis 86. The first aperture 262 and the second aperture(s) 266 can extend axially through the valve seat 238 to provide fluid communication between the inner and outer portions of the first cavity 78. In the example provided, the first aperture 262 is a central aperture coaxially disposed about the central axis 86 and open into the recess 258 and at the inward side 254 of the valve seat 238. In the example provided, the valve seat 238 includes a plurality of the second apertures 266 that can be circumferentially spaced about the central axis 86. While only two of the second apertures are illustrated, the valve seat 238 can include more than two of the second apertures 266. In the example provided, the second apertures 266 can be equally spaced apart in the circumferential direction to create a circular array of the second apertures 266 about the first aperture 262. The second apertures 266 can be radially outward of the first aperture 262 and can be open into the recess 258 and at the inward side 254 of the valve seat 238. The second apertures 266 can be radially inward of the shoulder 218.

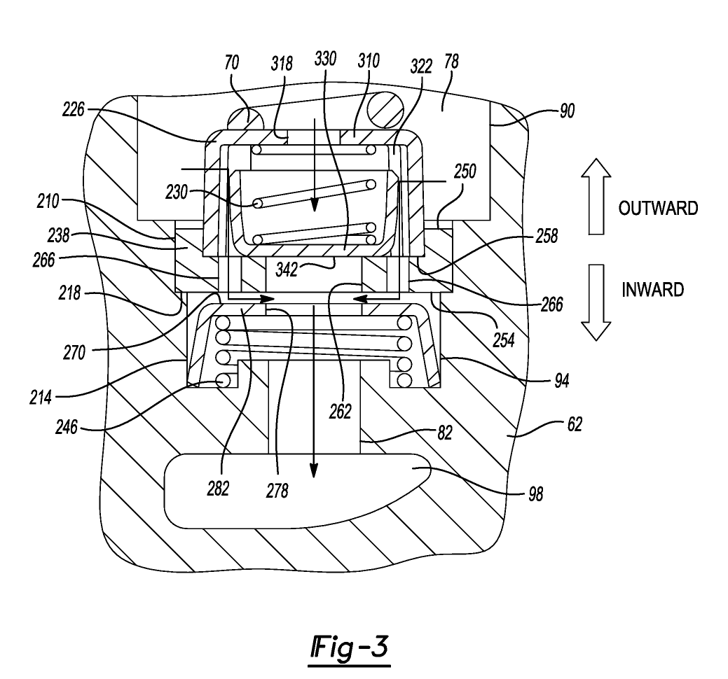

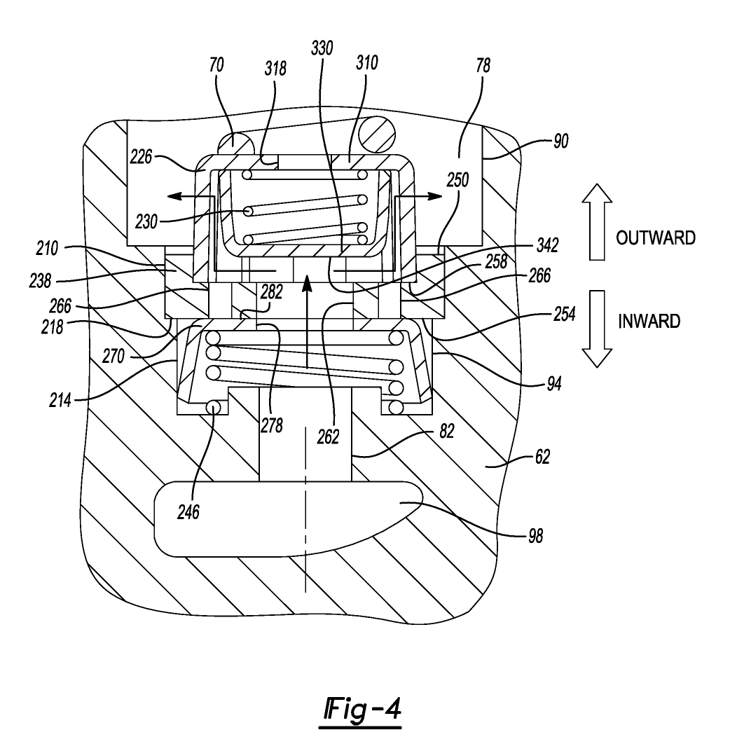

The pressure relief valve member 242 can be disposed within the third cylindrical portion 214 and can be configured to move axially in the third cylindrical portion 214 relative to the valve seat 238 between a closed position (shown in FIGS. 2 and 4) and an open position (shown in FIG. 3). In the example provided, the pressure relief valve member 242 can include an annular first plate 270 and a first sidewall 274. The annular first plate 270 can be a disk shape and can have an aperture 278 and can have an outermost diameter such that an axially outward facing surface 282 of the first plate 270 can extend radially outward of the second apertures 266. In the example provided, the aperture 278 can be coaxial with the central axis 86 and has a diameter that can be similar to the diameter of the first aperture 262 of the valve seat 238. The first sidewall 274 can be a generally cylindrical shape disposed about the central axis 86 that extends axially in the inward direction from the first plate 270. In the example provided, the first sidewall 274 can taper radially outward with increasing distance from the first plate 270, though other configurations can be used. The end of the first sidewall 274 that is distal to the first plate 270 can be radially outward of the boss 222.

When the pressure relief valve member 242 is in the closed position, the surface 282 can contact and seal with the inward side 254 of the valve seat 238 to inhibit fluid communication through the second apertures 266. When the pressure relief valve member 242 is in the open position, the surface 282 can be axially spaced apart from the inward side 254 of the valve seat 238 such that fluid communication is permitted through the second apertures 266.

The pressure relief valve spring 246 can be disposed in the third cylindrical portion 214 and can bias the first plate 270 axially toward the valve seat 238 (i.e., toward the closed position). In the example provided, the pressure relief valve spring 246 is a compression coil spring that can be coiled to have a diameter that is greater than the boss 222 and is greater than the aperture 278, but is less than the inner diameter of the first sidewall 274. Thus, the pressure relief valve spring 246 can be seated about the boss 222 to position the pressure relief valve spring 246 generally coaxial with the central axis 86. The pressure relief valve spring 246 can be seated radially within the first sidewall 274 and can contact the first plate 270 on a side that is opposite the surface 282.

The check valve retainer 226 can include a second plate 310 and a second sidewall 314. The second plate 310 can be a disk shape generally coaxial with the central axis 86 and can include an aperture 318. In the example provided, the aperture 318 can be coaxial with the central axis 86 and the second plate 310 can be disposed within the first cylindrical portion 90 of the first cavity 78. The second sidewall 314 can be a generally cylindrical body disposed coaxially about the central axis 86 and can extend axially in the inward direction from the second plate 310 toward the valve seat 238. The second sidewall 314 can include a plurality of side apertures 322 that extend radially through the second sidewall 314. In the example provided, the side apertures 322 are slits that extend longitudinally generally parallel to the central axis 86, though other configurations can be used, such as holes or other shapes for example. A distal end 326 of the second sidewall 314 (i.e., the end opposite the second plate 310) can have an outer diameter that can be received in the recess 258 of the valve seat 238. In the example provided, the outer diameter of the second sidewall 314 is such that the second sidewall 314 is press-fit into the recess 258. The distal end 326 can have an inner diameter that can be radially outward of the second apertures 266 such that the distal end 326 does not block the second apertures 266. In the example provided, the inward end of the plunger spring 70 can abut against a side of the second plate 310 that faces in the outward direction such that the plunger spring 70 and valve seat 238 can retain the check valve retainer 226 axially.

The check valve cup member 234 can be disposed between the valve seat 238 and the check valve retainer 226 and radially within the second sidewall 314. The check valve cup member 234 can be configured to move axially relative to the valve seat 238 between a closed position (shown in FIGS. 2 and 3) and an open position (shown in FIG. 4). In the example provided, the check valve cup member 234 can include a third plate 330 and a third sidewall 334. In the example provided, the third plate 330 can be a disk shape and may include one or more metering apertures 338 that extend axially through the third plate 330 and have relatively small diameters such that they allow only a small flowrate of fluid through the third plate 330. For example, the metering apertures 338 can be laser cut pin-holes such that a maximum flow rate through the metering apertures 338 is significantly less than the flow rate through the first or second apertures 262, 266 of the valve seat 238. In the example provided, the third plate 330 includes a plurality of the metering apertures 338. The metering apertures 338 can be aligned with the first aperture 262 of the valve seat 238 such that fluid flowing through the metering apertures 338 can flow directly into the first aperture 262. The third plate 330 can be radially inward of the second apertures 266 of the valve seat 238 and can have an outermost diameter that is greater than the first aperture 262 of the valve seat 238. The third sidewall 334 can be a generally cylindrical shape disposed about the central axis 86 that extends axially in the outward direction from the third plate 330. The end of the third sidewall 334 that is distal to the third plate 330 can be radially outward of the aperture 318 of the second plate 310.

When the check valve cup member 234 is in the closed position, an axially inward facing surface 342 of the third plate 330 can contact and seal with the outward side 250 of the valve seat 238 within the recess 258 to inhibit fluid communication through the first aperture 262. As described above, when the third plate 330 includes the metering apertures 338, some minor fluid flow can still pass through the metering apertures 338 to the first aperture 262 when the check valve cup member 234 is in the closed position. When the check valve cup member 234 is in the open position, the surface 342 can be axially spaced apart from the outward side 250 of the valve seat 238 such that fluid communication is permitted through the first aperture 262.

The check valve spring 230 can be disposed axially between the second plate 310 and the third plate 330 and can bias the third plate 330 toward the valve seat 238 (i.e., toward the closed position). In the example provided, the check valve spring 230 is a compression coil spring that can be coiled to have a diameter that is greater than the aperture 318 in the second plate 310, but less than the inner diameter of the third sidewall 334. Thus, the check valve spring 230 can be seated within the third sidewall 334 and be generally coaxial with the central axis 86. The check valve spring 230 can contact the outward side of the third plate 330 and the inward side of the second plate 310.

During nominal operation, the pressure relief valve member 242 and the check valve cup member 234 are in their respective closed positions. When the plunger 66 is pushed in the inward direction by the lever arm 42, such as during bang-lash, the plunger 66 can compress the fluid in the first cylindrical portion 90 to be a pressure greater than the pressure in the reservoir 98. When the plunger 66 is pushed in the outward direction (e.g., by the plunger spring 70), such as to take up slack in the chain 18, the pressure in the first cylindrical portion 90 can drop below the pressure in the reservoir 98.

Small increases in the pressure in the first cylindrical portion 90 (e.g., due to small movements or relatively slow movement of the plunger 66 in the inward direction) can cause fluid to flow through the metering apertures 338 toward the reservoir 98 via the first aperture 262 in the valve seat 238, the aperture 318 in the second plate 310, and the fluid passageway 82. These small pressures can be such that the force created on the first plate 270 at the second apertures 266 of the valve seat 238 does not overcome the spring force of the pressure relief valve spring 246 and does not move the pressure relief valve member 242 toward the open position. Likewise, small decreases in the pressure in the first cylindrical portion 90 (e.g., due to small movements or relatively slow movement of the plunger 66 in the outward direction) can cause fluid to flow through the metering apertures into the first cylindrical portion 90. These small pressures can be such that the force created on the third plate 330 at the first aperture 262 of the valve seat 238 does not overcome the spring force of the check valve spring 230 and does not move the check valve cup member 234 toward the open position.

Larger increases in pressure in the first cylindrical portion 90 (e.g., due to larger movements or faster movement of the plunger 66 in the inward direction) can cause the fluid to exert a force in the inward direction on the first plate 270 (e.g., through the second apertures 266 of the valve seat 238) that can overcome the force of the pressure relief valve spring 246 and can move the pressure relief valve member 242 toward the open position. As such, when the pressure differential between the first cylindrical portion 90 and the reservoir 98 exceeds a first predetermined pressure differential (e.g., corresponding to the spring force of the pressure relief valve spring 246), the first plate 270 can move away from the valve seat 238 to permit fluid to flow from the first cylindrical portion 90 through the second apertures 266 and toward the reservoir 98, as shown in FIG. 3. At the same time, the third plate 330 can remain stationary and seated on the valve seat 238. Contact between the first sidewall 274 and an inward end of the third cylindrical portion 214 can limit the distance that the first plate 270 can travel apart from the valve seat 238. Thus, the axial length of the first sidewall 274 can limit the maximum flow rate through the second apertures 266.

Larger decreases in pressure in the first cylindrical portion 90 (e.g., due to larger movements or faster movement of the plunger 66 in the outward direction) can cause the fluid to exert a force in the outward direction on the first plate 270 (e.g., through the first aperture 262 of the valve seat 238) that can overcome the force of the check valve spring 230 and can move the check valve cup member 234 toward the open position. As such, when the pressure differential between the first cylindrical portion 90 and the reservoir 98 decreases below a second predetermined pressure differential (e.g., corresponding to the spring force of the check valve spring 230), the third plate 330 can move away from the valve seat 238 to permit fluid to flow from the fluid passageway 82 through the first aperture 262 and toward the first cylindrical portion 90, as shown in FIG. 4. At the same time, the first plate 270 can remain stationary and seated on the valve seat 238. Contact between the third sidewall 334 and the second plate 310 can limit the distance that the third plate 330 can travel apart from the valve seat 238. Thus, the axial length of the third sidewall 334 can limit the maximum flow rate through the first aperture 262.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A hydraulic tensioner for a wrapped power transmission device between two rotating members, the hydraulic tensioner comprising:
a housing including a first cavity and a passageway, the passageway being open into an inward end of the first cavity;
a piston disposed about the axis, an inward end of the piston being disposed within the first cavity, an outward end of the piston being external of the housing, the piston being configured to slide axially relative to the housing;
a piston spring disposed within the first cavity and biasing the piston in an outward direction toward the power transmission device;
a valve seat including a first aperture and a second aperture that extend axially through the valve seat, the first aperture being disposed about the axis, the second aperture being radially outward of the first aperture;
a first valve member including a first plate that includes a third aperture, the third aperture aligned with the first aperture, the first plate extending radially outward of the second aperture, the first plate being axially movable between a closed position wherein the first plate seals with an inward side of the valve seat to inhibit fluid flow through the second aperture, and an open position wherein the first plate is axially spaced apart from the valve seat to permit fluid communication through the second aperture;
a first valve spring biasing the first plate toward the closed position of the first plate;
a valve retainer including a second plate fixedly coupled to the valve seat;
a second valve member including a third plate disposed axially between the second plate and the valve seat, the third plate extending radially outward of the first aperture, the second aperture being radially outward of the third plate, the third plate being axially movable between a closed position wherein the third plate seals with an outward side of the valve seat to inhibit fluid communication through the first aperture while permitting fluid communication through the second aperture, and an open position wherein the third plate is axially spaced apart from the valve seat to permit fluid communication through the first aperture; and
a second valve spring biasing the third plate toward the closed position of the third plate.

2. The hydraulic tensioner of claim 1, wherein the valve retainer includes a sidewall disposed about the axis, the sidewall of the valve retainer extending axially from the second plate in an inward direction toward the valve seat and fixedly coupling the second plate to the valve seat.

3. The hydraulic tensioner of claim 2, wherein the first cavity includes a first cylindrical portion and a shoulder, the piston being disposed in the first cylindrical portion, the shoulder extending radially inward of the first cylindrical portion and abutting an inward side of the valve seat to inhibit inward axial movement of the valve seat.

4. The hydraulic tensioner of claim 3, wherein the piston spring contacts an outward side of the second plate.

5. The hydraulic tensioner of claim 2, wherein the valve seat includes a recess and a distal end of the sidewall of the retainer is disposed in the recess of the valve seat.

6. The hydraulic tensioner of claim 2, wherein the second valve member includes a sidewall, the sidewall of the second valve member extending axially from the third plate in an outward direction toward the second plate.

7. The hydraulic tensioner of claim 6, wherein the second valve spring contacts an inward side of the second plate and an outward side of the third plate.

8. The hydraulic tensioner of claim 2, wherein the sidewall of the valve retainer includes a plurality of apertures extending radially through the sidewall of the valve retainer.

9. The hydraulic tensioner of claim 1, wherein the valve seat includes a plurality of the second apertures.

10. The hydraulic tensioner of claim 1, wherein the first valve member includes a sidewall, the sidewall of the first valve member extending axially from the first plate in an inward direction away from the valve seat.

11. The hydraulic tensioner of claim 1, wherein the third plate includes a metering aperture aligned with the first aperture.

12. The hydraulic tensioner of claim 1, wherein the second plate includes an aperture that is coaxial with the axis.

13. A hydraulic tensioner for a wrapped power transmission device between two rotating members, the hydraulic tensioner comprising:
a housing including a first cavity and a passageway, the passageway being open into an inward end of the first cavity;
a piston disposed about the axis, an inward end of the piston being disposed within the first cavity, an outward end of the piston being external of the housing, the piston being configured to slide axially relative to the housing;
a piston spring disposed within the first cavity and biasing the piston in an outward direction toward the power transmission device;
a valve seat including a first aperture and a second aperture, the first and second apertures extending axially through the valve seat, the first aperture being disposed about the axis, the second aperture being radially outward of the first aperture;
a first valve member including a first plate, the first plate including a third aperture, the third aperture being disposed about the axis and aligned with the first aperture, the first plate extending radially outward of the second aperture, the first plate being axially movable between a closed position wherein the first plate contacts an inward side of the valve seat to inhibit fluid flow through the second aperture, and an open position wherein the first plate is axially spaced apart from the valve seat to permit fluid communication through the second aperture;
a first valve spring biasing the first valve member toward the closed position of the first plate;
a valve retainer including a second plate, a sidewall, and at least one aperture, the second plate being axially spaced apart from the valve seat, the sidewall of the valve retainer extending axially inward from the second plate toward the valve seat, a distal end of the sidewall of the valve retainer being fixedly coupled to the valve seat, the at least one aperture of the valve retainer extending through the second plate or the sidewall of the valve retainer;
a second valve member including a third plate disposed axially between the second plate and the valve seat, the third plate extending radially outward of the first aperture, the second aperture being radially outward of the third plate, the third plate being axially movable between a closed position wherein the third plate contacts an outward side of the valve seat to inhibit fluid communication through the first aperture while permitting fluid communication through the second aperture, and an open position wherein the third plate is axially spaced apart from the valve seat to permit fluid communication through the first aperture; and
a second valve spring disposed between the second and third plates and biasing the third plate toward the closed position of the third plate.

14. The hydraulic tensioner of claim 13, wherein the second valve member includes a sidewall that is disposed about the axis and extends axially from the third plate toward the second plate.

15. The hydraulic tensioner of claim 13, wherein the third plate includes a metering aperture aligned with the first aperture.
